(19) United States
(12) Patent Application Publication
(10) Pub. No.: US 2023/0245070 A1
(43) Pub. Date: Aug. 3, 2023

(54) SYSTEM AND METHOD SUPPORTING VIRTUAL HALLWAY COLLISION

(71) Applicant: Raytheon Company, Waltham, MA (US)

(72) Inventor: James J. Richardson, Temecula, CA (US)

(21) Appl. No.: 18/062,672

(22) Filed: Dec. 7, 2022

Related U.S. Application Data
(60) Provisional application No. 63/306,238, filed on Feb. 3, 2022.

(51) Int. Cl. G06Q 10/1093

(52) U.S. Cl. CPC G06Q 10/1095

(57) ABSTRACT

A method includes identifying, using at least one processing device, a time period in which a first user is online and available based on the first user's schedule. The method also includes identifying, using the at least one processing device, one or more second users who are online and available, where the one or more second users are remote from the first user. The method further includes sending, using the at least one processing device, invitations to the first and second users. In addition, the method includes, in response to at least two of the users accepting the invitations, initiating, using the at least one processing device, a communication session between the at least two users.

### CROSS-REFERENCE TO RELATED APPLICATION AND PRIORITY CLAIM

This application claims priority under 35 U.S.C. § 119(e) to U.S. Provisional Patent Application No. 63/306,238 filed on Feb. 3, 2022. This provisional application is hereby incorporated by reference in its entirety.

### TECHNICAL FIELD

This disclosure is generally directed to virtual meeting systems. More specifically, this disclosure is directed to a system and method supporting virtual hallway collision.

### BACKGROUND

With the significant increase in employees working from home or otherwise working remotely, chance social encounters (referred to as “hallway collisions”) in the workplace have been lost. Many adverse results are attributable to this loss, such as innovation atrophy, reduced intellectual property (IP) development, and workforce isolation. While there are many tools for remote interaction, employees are often hesitant to initiate a conversation without the “visual invitation” of a smile, nod, or positive body language that they would see during in-person encounters.

### SUMMARY

This disclosure is directed to a system and method supporting virtual hallway collision.

In a first embodiment, a method includes identifying, using at least one processing device, a time period in which a first user is online and available based on the first user's schedule. The method also includes identifying, using the at least one processing device, one or more second users who are online and available, where the one or more second users are remote from the first user. The method further includes sending, using the at least one processing device, invitations to the first and second users. In addition, the method includes, in response to at least two of the users accepting the invitations, initiating, using the at least one processing device, a communication session between the at least two users.

In a second embodiment, an apparatus includes at least one processing device configured to identify a time period in which a first user is online and available based on the first user's schedule. The at least one processing device is also configured to identify one or more second users who are online and available, where the one or more second users are remote from the first user. The at least one processing device is further configured to send invitations to the first and second users. In addition, the at least one processing device is configured, in response to at least two of the users accepting the invitations, to initiate a communication session between the at least two users.

In a third embodiment, a non-transitory computer readable medium contains computer readable program code that, when executed by one or more processors, causes the one or more processors to identify a time period in which a first user is online and available based on the first user's schedule. The non-transitory computer readable medium also contains computer readable program code that, when executed by the one or more processors, causes the one or more processors to identify one or more second users who are online and available, where the one or more second users are remote from the first user. The non-transitory computer readable medium further contains computer readable program code that, when executed by the one or more processors, causes the one or more processors to send invitations to the first and second users. In addition, the non-transitory computer readable medium contains computer readable program code that, when executed by the one or more processors, causes the one or more processors, in response to at least two of the users accepting the invitations, to initiate a communication session between the at least two users.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting virtual hallway collision according to this disclosure;

FIG. 2 illustrates an example device supporting virtual hallway collision according to this disclosure;

FIG. 3 illustrates an example architecture supporting virtual hallway collision according to this disclosure; and

FIG. 4 illustrates an example method for virtual hallway collision according to this disclosure.

### DETAILED DESCRIPTION

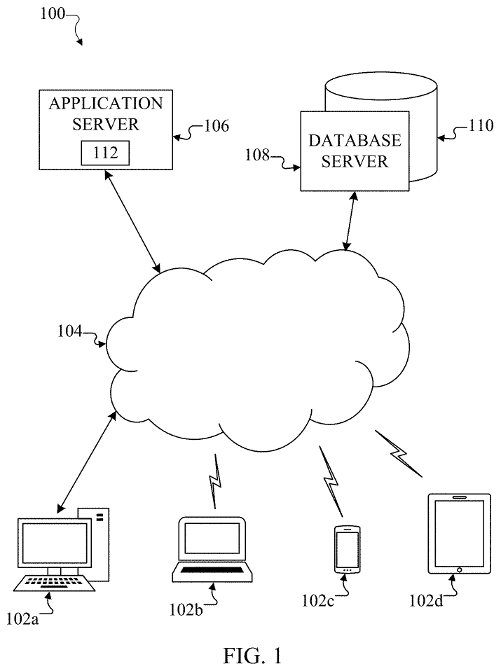

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, with the significant increase in employees working from home or otherwise working remotely, chance social encounters (referred to as “hallway collisions”) in the workplace have been lost. Many adverse results are attributable to this loss, such as innovation atrophy, reduced intellectual property (IP) development, and workforce isolation. While there are many tools for remote interaction, employees are often hesitant to initiate a conversation without the “visual invitation” of a smile, nod, or positive body language that they would see during in-person encounters. For instance, despite there being a myriad of chat apps with their various niche focuses and features, nearly all require users to proactively initiate each engagement. None of them provides the ability to recreate lost spontaneous interactions in the virtual realm as closely as possible to in-person experiences. The loss of spontaneous interactions can have negative impacts on both an employee workforce and an overall business.

This disclosure provides a system and method supporting virtual hallway collision, such as in the form of an app. The system and method are designed with the end goal of recreating in-person hallway collision experiences or other chance social encounters as closely as possible. For example, an employee may often remain at his or her desk working and then, about five to ten minutes before a meeting, leave the desk and walk to a designated meeting location. Enroute, the employee may happen across colleagues in the hallways who are also going to one or more meetings (perhaps the same meeting) or to the restroom, cafeteria, lab, back to their own offices from meetings, etc. At that point, it is common for the employee to pause and have a “hallway collision” social interaction with these individuals (sometimes more than one other person).

The system and method supporting virtual hallway collision described in this patent document recreate this experience, such as via the following operations. Users may opt-in to a virtual hallway collision app, which authorizes access to their MICROSOFT OUTLOOK calendar or other calendar, MICROSOFT TEAMS status or other status, and ZOOM or other visual conferencing system for use by the app. When a user is online (such as based on his or her TEAMS status) and is free (such as when nothing is scheduled for the current time in his or her calendar) for a configurable number of minutes (such as five or ten minutes) before a next meeting (such as per his or her calendar), the virtual hallway collision app can pop-up a dialog to jump into a TEAMS, ZOOM, or other chat session, video session, or other communication session with someone else (such as someone on the user's configured list of “people I know” or optionally any other random user). The dialog can allow the user to accept or reject the attempted communication session, and if accepted the virtual hallway collision app can connect the user to one or more other users via the communication session. Additional configuration options may include the user's preferred ratio of “people I know” versus random encounters. In some cases, the virtual hallway collision app may collect anonymized or personalized metrics to track the number of virtual hallway collisions created and other data/metrics for correlation with an organization's employee wellbeing, satisfaction, and engagement metrics.

In this way, the described system and method can help to recreate lost hallway collisions or other chance social encounters, thus mitigating the adverse effects noted previously. The described system and method can be used to identify times when chance social encounters would have likely occurred, and the described system and method can attempt to recreate those chance social encounters as closely as possible in the virtual realm. This allows the described system and method to recreate chance social encounters in the virtual realm that are far closer to the in-person paradigm or feel than other applications. Moreover, because the described system and method can invite people to participate in communication sessions, the described system and method help to leverage psychology to overcome the social reluctance of people to initiate remote or unplanned virtual interactions, even with close friends. Since the described system and method can initiate each social encounter, users are invited guests into each conversation and do not have to proactively initiate interactions. In addition, collected metrics can be used as a feedback mechanism to continuously improve objective results of the described system and method, such as by allowing users to rate each communication session and optionally enter one or more topics discussed. Among other things, this may allow for learning of various users' preferences in order to enable tailored future communication sessions.

FIG. 1 illustrates an example system 100 supporting virtual hallway collision according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and a network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information. At least some of the user devices 102a-102d can be configured to allow users to engage in communication sessions with each other to support virtual hallway collision functionality.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. The application server 106 supports the execution of one or more applications 112, at least one of which is designed to support virtual hallway collision functionality. For example, an application 112 may be configured to identify when users are available for brief or other communication sessions with one another, such as when a specified user of a specified user device 102a-102d will soon have a meeting and might be available for a brief interaction with one or more other users. The application 112 may also be configured to send invitations to one or more other users and initiate a communication session between the specified user's user device 102a-102d and at least one other user's user device 102a-102d. The application 112 may further be configured to collect metrics related to accepted, rejected, or concluded communication sessions.

The database server 108 operates to store and facilitate retrieval of various information used, generated, or collected by the application server 106 and the user devices 102a-102d in the database 110. For example, the database server 108 may store various information in relational database tables or other data structures in the database 110. In some embodiments, the database 110 can be used to store and facilitate retrieval of user preferences related to virtual hallway collision functionality. As particular examples, the database 110 may store information indicating whether users have opted-in to using the virtual hallway collision functionality and, if so, information regarding those users' statuses, calendars, and meetings. The database 110 may also store information indicating whether individual users have configured “people I know” lists (which are lists of people that the individual users have identified as being known to the individual users) and whether individual users have indicated that they would like to limit chance social encounters to users on their “people I know” lists or to include random users (which in some cases may be controlled by defining a ratio of encounters with known users to encounters with random users). The database 110 may further store information related to collected metrics associated with the virtual hallway collision functionality. Note that the database server 108 may also be used within the application server 106 to store information, in which case the application server 106 may store the information itself.

Although FIG. 1 illustrates one example of a system 100 supporting virtual hallway collision, various changes may be made to FIG. 1. For example, the system 100 may include any suitable number of user devices 102a-102d, networks 104, application servers 106, database servers 108, and databases 110. Also, these components may be located in any suitable locations and might be distributed over a large area. Further, functionalities described as being performed using one or more components in FIG. 1 may be performed by one or more other components in FIG. 1. For instance, the user devices 102a-102d may implement the virtual hallway collision functionality described in this patent document. In addition, while FIG. 1 illustrates one example operational environment in which virtual hallway collision functionality may be used, this functionality may be used in any other suitable system.

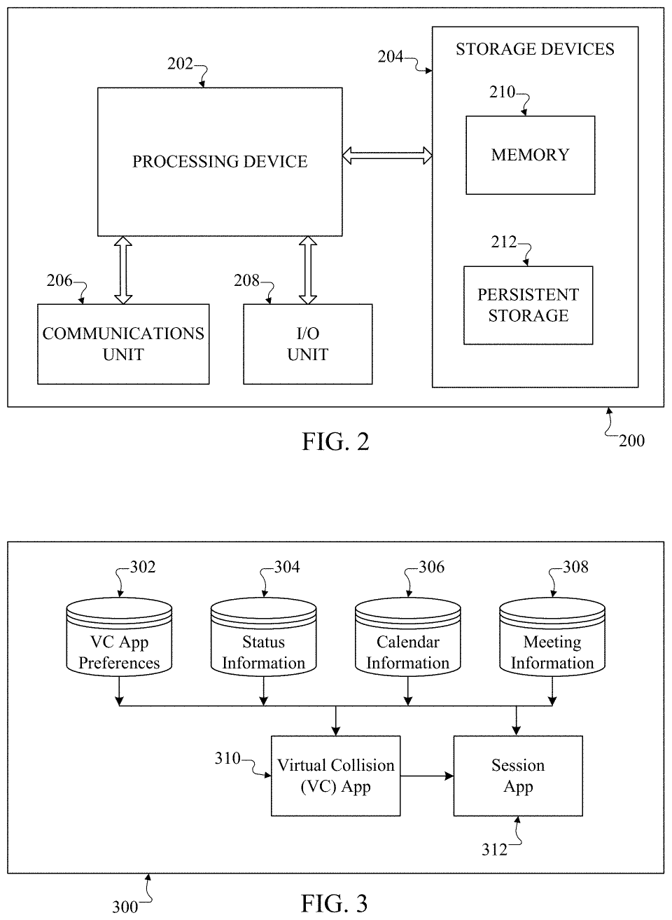

FIG. 2 illustrates an example device 200 supporting virtual hallway collision according to this disclosure. One or more instances of the device 200 may, for example, be used to at least partially implement the functionality of a user device 102a-102d, application server 106, or database server 108 in FIG. 1. For instance, in some cases, the device 200 may generally represent components in a user device, such as a personal computer, laptop computer, tablet computer, smartphone, or smart watch, that can be used by a user for whom virtual hallway collisions can be initiated. The device 200 may also or alternatively represent components in another device, such as a server or other computer, that supports the use of virtual hallway collision. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communications over the network(s) 104 in FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display or other suitable output device. Note, however, that the I/O unit 208 may be omitted if the device 200 does not require local I/O, such as when the device 200 represents a server or other device that can be accessed remotely.

Any number of user devices supporting virtual hallway collision functionality may be used in any suitable system. For example, the user devices may communicate over one or more wired or wireless networks with each other and with one or more application servers, other servers, databases, etc. The application servers, other servers, and databases may be used, for instance, to provide access to MICROSOFT OUTLOOK calendars or other calendars, MICROSOFT TEAMS statuses or other statuses, and ZOOM or other visual conferencing system functionality.

Although FIG. 2 illustrates one example of a device 200 supporting virtual hallway collision, various changes may be made to FIG. 2. For example, computing and communication devices and systems come in a wide variety of configurations, and FIG. 2 does not limit this disclosure to any particular computing or communication device or system.

FIG. 3 illustrates an example architecture 300 supporting virtual hallway collision according to this disclosure. For ease of explanation, the architecture 300 is described as being used by the application server 106 to support virtual hallway collision functionality for users of the user devices 102a-102d. However, the architecture 300 may be used by any other suitable device(s) (such as the user devices 102a-102d themselves) and in any other suitable system(s).

As shown in FIG. 3, the architecture 300 includes or has access to multiple data stores 302-308, where each data store 302-308 can be used to store specified information related to the virtual hallway collision functionality. In some embodiments, the data stores 302-308 may represent separate storage devices, such as separate databases 110. In other embodiments, the data stores 302-308 may represent portions of the same storage device(s), such as the same database 110. Note that the information in the data stores 302-308 may be stored in any suitable manner, such as separately or in common data structures.

In this example, the data store 302 is used to store virtual collision (VC) app preferences, which can represent preferences of users who might interact via the virtual hallway collision functionality. For example, the data store 302 may store information identifying which users have opted-in to usage of the virtual hallway collision functionality. The data store 302 may also store information indicating whether individual users (such as those who have opted-in) have created “people I know” lists and, if so, which people are on those individual users' lists. The data store 302 may further store information identifying whether individual users (such as those who have opted-in) have indicated that they would like to limit chance social encounters to users on their “people I know” lists or to include random users and by what amount.

The data store 304 is used to store status information related to users who have opted-in to usage of the virtual hallway collision functionality. For example, the data store 304 may store the status of each of these users over time, such as by storing information identifying the current status of each user. In some embodiments, the status of each user may represent the user's status as defined by MICROSOFT TEAMS or other application. The data store 306 is used to store calendar information related to users who have opted-in to usage of the virtual hallway collision functionality. For instance, the data store 306 may store meetings and other events as defined in at least one calendar for each of these users. In some embodiments, the at least one calendar of each user may represent the user's calendar as defined in MICROSOFT OUTLOOK or other application. The data store 308 is used to store meeting information related to users who have opted-in to usage of the virtual hallway collision functionality. For example, the data store 308 may store information used to establish chat sessions, video sessions, or other communication sessions between users. In some embodiments, the data store 308 may store information used to initiate MICROSOFT TEAMS, ZOOM, or other communication sessions between users.

Each of the data stores 302-308 here is accessible by one or more of a virtual collision app 310 and a communication session app 312. The virtual collision app 310 represents an application that can implement functionality for identifying when users might be receptive to chance social encounters and for initiating the establishment of communication sessions to support those chance social encounters. For example, the virtual collision app 310 may access calendar information for a specified user who has opted-in to usage of the virtual collision app 310 and determine if the user is currently available and has a meeting scheduled to begin within a specified threshold and possibly user-configurable time period (such as within five to ten minutes). If so, this may indicate that the specified user is available for a possible virtual collision during a specified time period, such as the time period between the current time and the user's next meeting time. As a result, the virtual collision app 310 can identify one or more other users who are on the specified user's “people I know” list or randomly select one or more other users (who are themselves also available). The virtual collision app 310 can initiate invitations to the specified user and the one or more other users to interact and, if at least two users accept the invitations, initiate a communication session between the at least two users. The virtual collision app 310 can perform these functions for each of a number of users (and possibly a very large number of users) in order to support chance social encounters between those users.

The communication session app 312 represents an application that can establish and enable communication sessions between users. For example, the communication session app 312 may represent a chat application that allows users to exchange chat messages, an audio conferencing application that allows users to engage in audio communications, or a video conferencing application that allows users to engage in audio/video communications. In some cases, the communication session app 312 may represent MICROSOFT TEAMS or ZOOM. In general, this disclosure is not limited to any particular type(s) of communication sessions between users to support chance social encounters.

In some cases, such as after a communication session has concluded, the virtual collision app 310 can collect information from one or more users in order to collect or identify one or more metrics. For example, the virtual collision app 310 may ask users to rate each communication session, such as by asking each user to provide an overall rating of the communication session (like using a 1-5 star ranking) and/or asking each user how the communication session made the user feel (like using five icons with faces ranging from frowning heavily to smiling heavily). Optionally, the virtual collision app 310 may ask users to identify one or more topics discussed, such as through the use of a drop-down menu or text entry box. Moreover, in some cases, the virtual collision app 310 can also or alternatively generate one or more metrics. For instance, the virtual collision app 310 may identify the number(s) of accepted or rejected invitations per user and whether those accepted or rejected invitations involved known or randomly-selected users. The virtual collision app 310 may also or alternatively identify the durations of accepted communication sessions, possibly splitting the measured durations into durations of accepted communication sessions involving known users and durations of accepted communication sessions involving randomly-selected users.

The virtual collision app 310 can use any of these or other metrics in any suitable manner. For example, among other things, metrics can be used to track app usage and impact trends for correlation with employee wellbeing, satisfaction, and engagement metrics. Individual user metrics can also be used to drive feedback mechanisms, continuously “learning” to improve invitation acceptance rates, auto-adjust configuration parameters and user preferences, and tailor future app experiences. As particular examples, the virtual collision app 310 can learn when users are more likely to engage in conversations, who certain users are more likely to interact with for longer or shorter periods of time, and which users appear to have common interests.

Note that the virtual collision app 310 here can use various data from one or more sources outside of the virtual collision app 310 when determining whether to initiate virtual collisions. For example, the virtual collision app 310 can use data from users' calendars (which may be obtained from one application) and data of users' statuses (which may be obtained from another application). In other words, in these embodiments, the virtual collision app 310 can be integrated with other applications in order to collect and use data from those other applications.

Although FIG. 3 illustrates one example of an architecture 300 supporting virtual hallway collision, various changes may be made to FIG. 3. For example, various components shown in FIG. 3 can be added, omitted, combined, further subdivided, replicated, or placed in any other suitable configuration according to particular needs. Also, the ability of users to opt-in may be optional, such as when an organization wants users to interact more often.

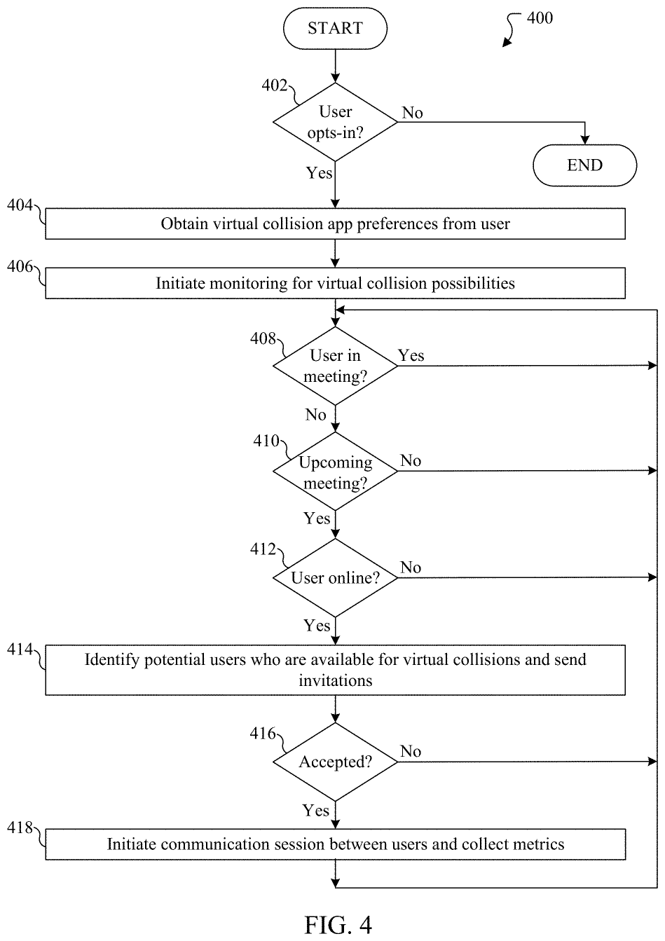

FIG. 4 illustrates an example method 400 for virtual hallway collision according to this disclosure. For ease of explanation, the method 400 is described as being performed using the application server 106 to support virtual hallway collision functionality for users of the user devices 102a-102d. However, the method 400 may be performed by any other suitable device(s) (such as the user devices 102a-102d themselves) and in any other suitable system(s).

As shown in FIG. 4, a determination is made whether a specified user opts-in to usage of a virtual collision app at step 402. This may include, for example, the application server 106 causing a user device 102a-102d associated with the specified user to present the specified user with an option to opt-in or opt-out of usage of the virtual collision app 310. If the specified user opts-out, the method 400 can end since no additional actions may be needed with the specified user.

If the specified user opts-in, preferences associated with the specified user are obtained at step 404. This may include, for example, the application server 106 causing the user device 102a-102d associated with the specified user to present various options that can be selected by the specified user. Example options may include whether the specified user would like to define a “people I know” list and who (if anyone) has been added to the list, whether the specified user would like to permit connections with random users unknown to the specified user, the time period prior to the specified user's meetings during which chance social encounters may be permitted, or other options. As a particular example, the specified user may be allowed to define a preferred ratio of encounters with known users to encounters with random users, where one value (such as zero) may allow for only encounters with known users and another value (such as one) may allow for only encounters with random users.

Monitoring is initiated for virtual collision possibilities at step 406. This may include, for example, the application server 106 accessing the specified user's calendar and starting the process of monitoring when the specified user might be available. As part of this monitoring process, a determination is made whether the specified user is currently in a meeting or otherwise unavailable at step 408. This may include, for example, the application server 106 reviewing the specified user's calendar and seeing if the specified user has a meeting scheduled at the current time. If not, a determination is made whether the specified user has an upcoming meeting at step 410. This may include, for example, the application server 106 reviewing the specified user's calendar and seeing if the specified user has a meeting scheduled to begin within a specified amount of time, such as within the next five to ten minutes (or other user-configurable or other time period). If so, a determination is made whether the specified user is currently online at step 412. This may include, for example, the application server 106 reviewing the specified user's status and seeing whether the specified user is actively logged in and performing any actions. If so, the specified user may be receptive to a chance social encounter.

One or more potential users who are available for virtual collisions are identified, and invitations are sent to the users at step 414. This may include, for example, the application server 106 seeing whether anyone on the specified user's “people I know” list or one or more random users are currently available. If there is at least one potential user who might be available, the application server 106 may send invitations to the specified user and the at least one potential user, such as an invitation that is displayed on the user devices 102a-102d of the specified user and the at least one potential user. A determination is made whether at least two users accepted the invitations at step 416. If so, a communication session can be initiated between the at least two users, and one or more metrics associated with the communication session may optionally be collected at step 418. This may include, for example, the application server 106 causing the communication session app 312 to establish a chat, audio, or video communication session between the users who accepted the invitations. This may also include the virtual collision app 310 collecting or generating one or more metrics associated with the communication session. One or more of the metrics may be based on user feedback, such as after the communication session has concluded.

Although FIG. 4 illustrates one example of a method 400 for virtual hallway collision, various changes may be made to FIG. 4. For example, while shown as a series of steps, various steps in FIG. 4 may overlap, occur in parallel, occur in a different order, or occur any number of times (possibly including zero times). Also, while FIG. 4 illustrates a specific combination of conditions that may need to be satisfied before a virtual collision for a specified user is identified, other conditions or other combinations of conditions (including one or more conditions not shown here) may be used. For instance, if the virtual collision app 310 is able to determine that the specified user often takes breaks around the same time each day, the virtual collision app 310 may use the current time's proximity to the user's expected break time to initiate one or more potential virtual collisions.

It should be noted that the functions shown in or described with respect to FIGS. 2 through 4 can be implemented in one or more devices (such as one or more user devices 102a-102d, the application server 106, or device 200) in any suitable manner. For example, in some embodiments, at least some of the functions shown in or described with respect to FIGS. 2 through 4 can be implemented or supported using one or more software applications or other software instructions that are executed by at least one processor of one or more devices. In other embodiments, at least some of the functions shown in or described with respect to FIGS. 2 through 4 can be implemented or supported using dedicated hardware components. In general, the functions shown in or described with respect to FIGS. 2 through 4 can be performed using any suitable hardware or any suitable combination of hardware and software/firmware instructions.

The following describes example embodiments of this disclosure that implement or relate to virtual hallway collision. However, other embodiments may be used in accordance with the teachings of this disclosure.

In a first embodiment, a method includes identifying, using at least one processing device, a time period in which a first user is online and available based on the first user's schedule. The method also includes identifying, using the at least one processing device, one or more second users who are online and available, where the one or more second users are remote from the first user. The method further includes sending, using the at least one processing device, invitations to the first and second users. In addition, the method includes, in response to at least two of the users accepting the invitations, initiating, using the at least one processing device, a communication session between the at least two users.

In a second embodiment, an apparatus includes at least one processing device configured to identify a time period in which a first user is online and available based on the first user's schedule. The at least one processing device is also configured to identify one or more second users who are online and available, where the one or more second users are remote from the first user. The at least one processing device is further configured to send invitations to the first and second users. In addition, the at least one processing device is configured, in response to at least two of the users accepting the invitations, to initiate a communication session between the at least two users.

In a third embodiment, a non-transitory computer readable medium contains computer readable program code that, when executed by one or more processors, causes the one or more processors to identify a time period in which a first user is online and available based on the first user's schedule. The non-transitory computer readable medium also contains computer readable program code that, when executed by the one or more processors, causes the one or more processors to identify one or more second users who are online and available, where the one or more second users are remote from the first user. The non-transitory computer readable medium further contains computer readable program code that, when executed by the one or more processors, causes the one or more processors to send invitations to the first and second users. In addition, the non-transitory computer readable medium contains computer readable program code that, when executed by the one or more processors, causes the one or more processors, in response to at least two of the users accepting the invitations, to initiate a communication session between the at least two users.

Any single one or any suitable combination of the following features may be used with the first, second, or third embodiment. The time period in which the first user is online and available may be identified by determining that the first user is available using a calendar of the first user and determining that the first user is online using a status of the first user. The first user may be determined as being available using the calendar of the first user by determining that the first user is not currently in a meeting and determining that the first user has an upcoming meeting scheduled to begin within a specified amount of time. The calendar and the status of the first user may represent data from outside an application that identifies the time period, identifies the one or more second users, sends the invitations, and initiates the communication session. At least one of the one or more second users may be selected from a list of people known to the first user. At least one of the one or more second users may be randomly selected. The sending of invitations to the first and second users prior to initiating the communication session between the at least two users may overcome social reluctance of the users to initiating remote or unplanned virtual interactions.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), a portable Universal Serial Bus (USB) drive, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
identifying, using at least one processing device, a time period in which a first user is online and available based on the first user's schedule;
identifying, using the at least one processing device, one or more second users who are online and available, the one or more second users remote from the first user;
sending, using the at least one processing device, invitations to the first and second users; and
in response to at least two of the users accepting the invitations, initiating, using the at least one processing device, a communication session between the at least two users.

2. The method of claim 1, wherein identifying the time period in which the first user is online and available comprises:
determining that the first user is available using a calendar of the first user; and
determining that the first user is online using a status of the first user.

3. The method of claim 2, wherein determining that the first user is available using the calendar of the first user comprises:
determining that the first user is not currently in a meeting; and
determining that the first user has an upcoming meeting scheduled to begin within a specified amount of time.

4. The method of claim 2, wherein the calendar and the status of the first user represent data from outside an application that identifies the time period, identifies the one or more second users, sends the invitations, and initiates the communication session.

5. The method of claim 1, wherein at least one of the one or more second users is selected from a list of people known to the first user.

6. The method of claim 1, wherein at least one of the one or more second users is randomly selected.

7. The method of claim 1, wherein sending the invitations to the first and second users prior to initiating the communication session between the at least two users overcomes social reluctance of the users to initiating remote or unplanned virtual interactions.

8. An apparatus comprising:
at least one processing device configured to:
identify a time period in which a first user is online and available based on the first user's schedule;
identify one or more second users who are online and available, the one or more second users remote from the first user;
send invitations to the first and second users; and
in response to at least two of the users accepting the invitations, initiate a communication session between the at least two users.

9. The apparatus of claim 8, wherein, to identify the time period in which the first user is online and available, the at least one processing device is configured to:
determine that the first user is available using a calendar of the first user; and
determine that the first user is online using a status of the first user.

10. The apparatus of claim 9, wherein, to determine that the first user is available using the calendar of the first user, the at least one processing device is configured to:
determine that the first user is not currently in a meeting; and
determine that the first user has an upcoming meeting scheduled to begin within a specified amount of time.

11. The apparatus of claim 9, wherein the calendar and the status of the first user represent data from outside an application that is configured when executed by the at least one processing device to identify the time period, identify the one or more second users, send the invitations, and initiate the communication session.

12. The apparatus of claim 8, wherein the at least one processing device is configured to select at least one of the one or more second users from a list of people known to the first user.

13. The apparatus of claim 8, wherein the at least one processing device is configured to randomly select at least one of the one or more second users.

14. The apparatus of claim 8, wherein the at least one processing device is configured to initiate the communication session between the at least two users after the at least two users have accepted the invitations to overcome social reluctance of the users to initiating remote or unplanned virtual interactions.

15. A non-transitory computer readable medium containing computer readable program code that, when executed by one or more processors, causes the one or more processors to:
identify a time period in which a first user is online and available based on the first user's schedule;
identify one or more second users who are online and available, the one or more second users remote from the first user;
send invitations to the first and second users; and
in response to at least two of the users accepting the invitations, initiate a communication session between the at least two users.

16. The non-transitory computer readable medium of claim 15, wherein the computer readable program code that when executed causes the one or more processors to identify the time period in which the first user is online and available comprises:
computer readable program code that when executed causes the one or more processors to:
determine that the first user is available using a calendar of the first user; and
determine that the first user is online using a status of the first user.

17. The non-transitory computer readable medium of claim 16, wherein the computer readable program code that when executed causes the one or more processors to determine that the first user is available using the calendar of the first user comprises:
computer readable program code that when executed causes the one or more processors to:
determine that the first user is not currently in a meeting; and
determine that the first user has an upcoming meeting scheduled to begin within a specified amount of time.

18. The non-transitory computer readable medium of claim 16, wherein the calendar and the status of the first user represent data from outside an application that comprises the computer readable program code.

19. The non-transitory computer readable medium of claim 15, wherein the computer readable program code when executed causes the one or more processors to select at least one of the one or more second users from a list of people known to the first user.

20. The non-transitory computer readable medium of claim 15, wherein the computer readable program code when executed causes the one or more processors to randomly select at least one of the one or more second users.
